(19) United States
(12) Patent Application Publication
(10) Pub. No.: US 2015/0302620 A1
(43) Pub. Date: Oct. 22, 2015

(54) SYSTEMS AND METHODS FOR DISPLAYING PERSONALITY ASSESSMENT RESULTS

(71) Applicant: Personal Strengths Publishing, Inc., Carlsbad, CA (US)

(72) Inventors: Timothy J. Scudder, Carlsbad, CA (US); Kent Mitchell, Carlsbad, CA (US)

(73) Assignee: Personal Strengths Publishing, Inc., Carlsbad, CA (US)

(21) Appl. No.: 14/258,241

(22) Filed: Apr. 22, 2014

(51) Int. Cl. G06T 11/20; G09B 19/00

(52) U.S. Cl. CPC G06T 11/206; G09B 19/00; G06T 2200/28

(57) ABSTRACT

Printed material, systems, media, and methods for displaying personality assessment results using a modified SDI® Triangle which comprises three sides of equal length, three vertices, three axis lines, seven demarcated MVS regions representing seven well states into which a person is classifiable and covering an entire area of the triangle, and thirteen CS regions representing thirteen conflict states into which a person is classifiable and also covering the entire area of the triangle so as to overlap with the MVS regions. The MVS regions may comprise a hexagon-shaped MVS Hub region in a center of the triangle and six MVS regions surrounding the MVS Hub region. Similarly, the CS regions may comprise a hexagon-shaped CS Hub region in the center of the triangle and twelve CS regions surrounding the hexagon-shaped CS Hub region.

### BACKGROUND

1. Field of the Invention

The embodiments described herein are generally directed to personality assessment, and, more particularly, to systems and methods for displaying results of personality testing or assessment of a person or groups of people using a unique triangle.

2. Description of the Related Art

Understanding SDI®

The Strength Deployment Inventory® (SDI®) is a dual-state personality assessment based on what motivates people and what brings them a sense of self-worth. Even though the SDI® is a personality assessment, it is also about relationships. It is based on how people are motivated in the context of their relationships with others. When used effectively, the SDI® can increase self-awareness, interpersonal awareness, personal effectiveness, and/or interpersonal effectiveness.

Working with the SDI® begins with an awareness of self and others. This awareness can lead to greater understanding. Increased understanding may then lead to greater acceptance or tolerance. This increased acceptance ideally leads to greater appreciation of self and others, and to greater effectiveness in relationships. New understanding empowers people to make better choices, and awareness is the foundation for understanding.

The SDI® was first published in 1971 by Elias Porter. Porter began creating personality assessments based on Erich Fromm's descriptions of personality types, which were an advancement of Sigmund Freud's ideas. Porter's goal was to create something that would be useful for people, not a diagnostic or predictive tool. As he continued his developmental, academic, and consulting work, he created several versions of his assessment, incorporating features such as a primary drive for self-worth, a focus on strengths, descriptions of conflict sequences, and the use of colors to identify personality types. The SDI® was the first personality assessment to use colors in this way. Today, the SDI® is available in over twenty languages.

Many views of personality are based on behavior or what people generally do. However, the SDI®, which is based on Relationship Awareness Theory, goes deeper. It holds that behavior comes from people's character structure, and that character arises from a system of personal motivations. The SDI® assessment has six scales, which are subdivided into two sets of three to represent two temporal-affective states of personality: (a) when things are going well; and (b) when there is conflict. The SDI® describes seven distinct ways that people are motivated when things are going well, and thirteen distinct ways that people's motivations can change as they are faced with conflict.

In the SDI®, the Motivational Value System (MVS) is a fairly constant set of motives and values that serve as a basis for choosing and giving purpose to behavior, focusing attention on certain things while ignoring others, and perceiving and judging self and others. Every MVS is a blend or combination of three primary motives: Blue (altruistic-nurturing), Red (assertive-directing), and Green (analytic-autonomizing), referred to herein as “Well Blue,” “Well Red,” and “Well Green,” respectively. People with the same MVS generally agree about why they do things, although they may not necessarily agree about what to do.

In addition, the Conflict Sequence (CS) is a series of changes in motivation during conflict that typically results in a related series of changes in behavior. There are three stages in a CS, characterized by a concentration of energy and a diminishing focus as follows:
Stage One: focus on self, problem, and other;
Stage Two: focus on self and problem; and
Stage Three: focus on self

As with the MVS, the CS can be represented by a blend or combination of three primary motives: Blue (accommodating), Red (asserting), and Green (analyzing), referred to herein as “Conflict Blue,” “Conflict Red,” and “Conflict Green,” respectively. As its name suggests, a “Conflict Sequence” is an order or pattern of conflict. In SDI® terms, a CS is the order in which a person experiences Blue (harmony-seeking), Red (outcome-seeking), and Green (logic-seeking) motivations during the course of conflict.

Determining SDI® Score Sets

As mentioned above, in the SDI®, two sets of scores are determined for an individual: (1) an MVS set comprising a Well Blue (WB) score, a Well Red (WR) score, and a Well Green (WG) score, and (2) a CS set comprising a Conflict Blue (CB) score, a Conflict Red (CR) score, and a Conflict Green (CG) score. Each score may be a positive integer between zero and one hundred inclusive, with the requirement that each set of scores sum to one hundred. Thus, the scores satisfy:

0≦WB≦100; 0≦WR≦100; 0≦WG≦100; and WB+WR+WG=100.

0≦CB≦100; 0≦CR≦100; 0≦CG≦100; and CB+CR+CG=100.

The scores may be determined using one or more ipsative assessments completed by the individual. For example, the assessment(s) may comprise a series of questions or prompts which require the individual to allocate ten points among three options or prompts, posed in the form of different sentence endings. Each prompt is associated with either the MVS or CS set of scores. If the prompt is associated with the MVS set of scores, each of the three possible options is associated with one of either WB, WR, or WG. Specifically, exactly one option is associated with WB, exactly one different option is associated with WR, and exactly one different option is associated with WG. Similarly, if the prompt is associated with the CS set of scores, each of the three possible options is associated with one of either CB, CR, or CG. That is, exactly one option is associated with CB, exactly one different option is associated with CR, and exactly one different option is associated with CG.

For instance, a simple example prompt with options for the MVS set (when things are going well) may be:

I enjoy things most when I am . . .

_{——}(1) helping others do what they want to do.

_{——}(2) getting others to do what I want to do.

_{——}(3) doing what I want to do without having to count on others.

In this example, the individual has the option of allocating all ten points to one of the sentence endings, or splitting the ten points between two or three of the above prompts or options. For example, if the individual were to assign 5 points to prompt (1), 2 points to prompt (2), and 3 points to prompt (3), the individual's WB score would be incremented by 5, the individual's WR score would be incremented by 2, and the individual's WG score would be incremented by 3.

If there are ten prompts in the assessment(s) associated with the MVS set of scores, then typically each prompt represents ten points, so that the total points assigned is 100, split between the WB, WR and WG points entered by the individual for each prompt. The total points for WB, WR and WG after the individual has allocated points to each prompt is always 100. Thus, if the individual allocated a total of 25 points to WB, 38 points to WR, and 37 points to WG, the individual MVS set of scores would be represented as {WB=25, WR=38, WG=37}.

A simple example prompt with options for the CS set of scores (conflict state, when things are going wrong) may be:

In getting along with difficult people, I usually . . .

_{——}(1) find it easier to just go along with their wishes for the moment.

_{——}(2) find them as challenges to be overcome.

_{——}(3) respect their rights and insist that they respect my rights and interests.

If there are ten prompts associated with the CS set of scores, and the individual assigns ten points each between the answers to each prompt, the total of the CB, CR and CG scores is 100. In other words, WB+WR+WG=100 and CB+CR+CG=100.

SDI® Triangle

In the SDI®, the MVS set of scores and CS set of scores are graphed in the form of an arrow onto an SDI® Triangle. FIG. 1 illustrates the MVS regions of a conventional SDI® Triangle. There are seven MVS regions—M1-M7—of the SDI® Triangle, representing the seven distinct ways that people are motivated when things are going well:
M1 represents the Blue (B) Motivational Value System. Generally, people classified in M1 are motivated by the protection, growth, and welfare of others, and have a strong desire to help others who can genuinely benefit.
M2 represents the Red (R) Motivational Value System. Generally, people classified in M2 are motivated by task accomplishment and achieving results, and have a strong desire to set goals, take decisive action, and claim earned rewards.
M3 represents the Green (G) Motivational Value System. Generally, people classified in M3 are motivated by meaningful order and thinking things through, and have a strong desire to pursue independent interests, to be practical, and to be fair.
M4 represents the Red-Blue (RB) Motivational Value System. Generally, people classified in M4 are motivated by the maximum growth and development of others, and have a strong desire to direct, persuade, or lead others for the benefit of others.
M5 represents the Red-Green (RG) Motivational Value System. Generally, people classified in M5 are motivated by intelligent assertiveness and fairness in competition, and have a strong desire to develop strategy and assess risks and opportunities.
M6 represents the Blue-Green (BG) Motivational Value System. Generally, people classified in M6 are motivated by developing self-sufficiency in self and others, and have a strong desire to analyze the needs of others and to help others help themselves.
M7 is the MVS hub, which represents a Blue-Red-Green blended Motivational Value System. Generally, people classified in M7 are motivated by flexibility and adapting to others or situations, and have a strong desire to collaborate with others and to remain open to different options and viewpoints.

FIG. 2 illustrates the CS regions of a conventional SDI® Triangle. There are thirteen CS regions—C1-C13—of the SDI® Triangle, representing the thirteen distinct ways that people's motivations can change as they are faced with conflict:
C1 represents a Blue-Red-Green (B-R-G) conflict sequence. Generally, people classified in C1 want to keep peace and harmony. If that does not work, they want to take a stand for their rights. If that does not work, they may feel compelled to withdraw as a last resort.
C2 represents a Blue-Green-Red (B-G-R) conflict sequence. Generally, people classified in C2 want to keep harmony and goodwill. If that does not work, they want to disengage and save what they can. If that does not work, they may feel compelled to fight, possibly in an explosive manner.
C3 represents a Blue-[Red/Green] (B-[RG]) conflict sequence. Generally, people classified in C3 want to keep harmony and accommodate the opposition. If that does not work, they want to make a choice based on what is best for everyone: to rely on logic and principle or to employ assertive strategies to prevent defeat.
C4 represents a Red-Blue-Green (R-B-G) conflict sequence. Generally, people classified in C4 want to challenge conflict directly. If that does not work, they want to restore or preserve harmony. If that does not work, they may feel compelled to withdraw from the situation or end the relationship.
C5 represents a Red-Green-Blue (R-G-B) conflict sequence. Generally, people classified in C5 want to prevail through competition. If that does not work, they want to use logic, reason, and rules. If that does not work, they may feel compelled to surrender as a last resort.
C6 represents a Red-[Green/Blue] (R-[GB]) conflict sequence. Generally, people classified in C6 want to assert their rights and win. If that does not work, they want to make a choice depending on what is better in the situation: to give in with conditions or to disengage and save what they can.
C7 represents a Green-Blue-Red (G-B-R) conflict sequence. Generally, people classified in C7 want to carefully examine the situation. If that does not work, they want to defer to other people in the interest of harmony. If that does not work, they may feel compelled to fight, possibly in an explosive manner.
C8 represents a Green-Red-Blue (G-R-B) conflict sequence. Generally, people classified in C8 want to analyze the situation logically. If that does not work, they want to forcefully press for a logical resolution. If that does not work and others have more power in the situation, they may surrender.
C9 represents a Green-[Blue/Red] (G-[BR]) conflict sequence. Generally, people classified in C9 want to maintain order and principles. If that does not work, they want to make a choice, depending on what is more reasonable in the situation: to give in with conditions or to forcefully engage.
C10 represents a [Blue/Red]-Green ([BR]-G) conflict sequence. Generally, people classified in C10 want to press assertively to maintain harmony and goodwill, but they do not want to sacrifice results for harmony. If that does not work, they may decide to withdraw from the situation.
C11 represents a [Red/Green]-Blue ([RG]-B) conflict sequence. Generally, people classified in C11 want to engage conflict quickly, but indirectly, with thoughtful strategies. If that does not work and others have more power in the situation, they may surrender.
C12 represents a [Blue/Green]-Red ([BG]-R) conflict sequence. Generally, people classified in C12 want to maintain peace and harmony with caution regarding the personal costs of doing so. If that does not work, they may feel compelled to fight, possibly in an explosive manner.
C13 represents a [Blue/Red/Green] ([BRG]) conflict sequence. Generally, people classified in C13 want to determine the most appropriate response to each situation and choose an accommodating, assertive, or analytical approach. Their approach differs according to the situation, rather than following a fixed sequence.

Notably, each CS region is represented by three letters (B, R, and G) arranged in a particular order, representing the three stages in a conflict sequence, discussed above. For example, an individual in B-R-G (i.e., C1) would experience Blue (harmony-seeking) in Stage One of the CS, Red (outcome-seeking) in Stage Two of the CS, and Green (logic-seeking) in Stage Three of the CS. The brackets indicate that a person may experience the bracketed motivations in any order. For example, an individual in B-[RG] would experience Blue in Stage One, and either Red in Stage Two and Green in Stage Three or Green in Stage Two and Red in Stage Three.

The MVS and CS regions, described above, are overlaid or superimposed on each other to create the conventional SDI® Triangle, illustrated in FIG. 3, which has three sides of equal length and in which each internal angle is 120°. Generally, the SDI® Triangle is shaded with blue, red, and green (not shown). Specifically, the area covered by M1 is primarily blue, the area covered by M2 is primarily red, the area covered by M3 is primarily green, the area covered by M4 is a blend of blue into red, the area covered by M5 is a blend of red into green, the area covered by M6 is a blend of blue into green, and the area covered by M7 is a primarily white (i.e., representing a blend of blue, red, and green). It should be understood that the colors and blends also underlie the CS regions. For example, since the area covered by M1 is primarily blue, the area covered by C3 is also primarily blue and portions of the areas covered by C1 and C2 bordering C3 are also primarily blue.

Graphing Individuals on an SDI® Triangle

The MVS set of scores determined for an individual are mapped onto the SDI® Triangle as a point, dot, or other indication and the CS set of scores determined for an individual are mapped onto the SDI® Triangle as an arrowhead or other indication, using the axes labeled B, R, and G in FIG. 3. Specifically, each axis may be marked so as to split the axis within the SDI® Triangle into equal segments, with each segment or marking representing a score. For instance, as illustrated in FIG. 3, each axis is split into one hundred equal segments with nine equally-spaced numbered score markings of ten, twenty, thirty, forty, fifty, sixty, seventy, eighty, and ninety from the point at which the axis bisects a side of the SDI® Triangle to a vertex of the SDI® Triangle, and nine equally spaced scale markings between each of the numbered score markings (for simplicity of illustration, the nine scale markings between each pair of numbered score markings are not shown in the drawings). Although the bisection point and vertex point are not marked, it should be understood that the bisection point represents the score zero along an axis and the vertex represents the score one hundred along the axis. It should also be evident that the axes intersect with each other in the middle of the SDI® Triangle exactly one third of the way from each axis' bisection point to its vertex. In addition, to aid in score determinations, for each of the nine equally-spaced numbered score markings on each axis (e.g. 10, 20, etc.), a guide line can be drawn orthogonal to the axis across the entire SDI® Triangle (i.e., from side to side), resulting in a total of twenty-seven such guide lines (i.e., nine for each of three axes), as illustrated in FIG. 4. For simplicity of illustration, these guide lines are omitted from the figures used to illustrate the various examples described herein.

As a further aid, each axis and its set of nine orthogonal guide lines can be depicted in the color associated with that particular axis. In other words, the B axis and each of the nine guide lines orthogonal to the B axis can be drawn, printed, or displayed in blue. Similarly, the R axis and each of the nine guide lines orthogonal to the R axis can be drawn, printed, or displayed in red. Furthermore, the G axis and each of the nine guide lines orthogonal to the G axis can be drawn, printed, or displayed in green.

FIG. 5 illustrates how each score in an exemplary MVS set of scores {WB=30, WR=20, WG=50} may be mapped onto the SDI® Triangle using its corresponding axis (i.e., B, R, G). Specifically, WB=30 corresponds to the score thirty indicated by the circle on axis B, WR=20 corresponds to the score twenty indicated by the circle on axis R, and WG=50 corresponds to the score fifty indicated by the circle on axis G. An intersection of these three scores can then be determined, for example, using the guide lines described above with respect to FIG. 4. Specifically, each score on the B, R, and G axes correspond to a line—which may or may not correspond exactly to a guide line, may be visible, imaginary, drawn to be visible, etc.—that is orthogonal to that respective axis. These three lines (i.e., one for each of the three axes) intersect at exactly one point within the SDI® Triangle. Accordingly, an indication, such as dot 502, may be drawn, displayed, or otherwise provided at that point.

FIG. 6 illustrates how each score in an exemplary CS set of scores {CB=50, CR=40, CG=10} may be mapped onto the same SDI® Triangle as shown in FIG. 5, again using the corresponding axes. Specifically, CB=50 corresponds to the score fifty indicated by the circle on axis B, CR=40 corresponds to the score forty indicated by the circle on axis R, and CG=10 corresponds to the score ten indicated by the circle on axis G. Again, each score on the B, R, and G axes correspond to a line that is orthogonal to that respective axis. These three lines intersect at exactly one point within the SDI® Triangle. Accordingly, an indication, such as arrowhead 504, may be drawn, displayed, or otherwise provided at that point. It should be understood that the MVS and CS sets of scores are not necessarily multiples of ten, but in that case the points can be placed on the respective scale markings counted from the respective numbered score marking. For example, CB=55 would be marked by counting five scale markings from the number 50 on the B axis, then a line can be drawn perpendicular to that axis to intersect with the CG and CR lines.

While FIGS. 5 and 6 and the above description illustrate the MVS set of scores being mapped first and the CS set of scores being mapped second, it should be understood that the sets of scores may be mapped in any order, including simultaneously.

As illustrated in FIG. 7, a line can be drawn between dot 502 and arrowhead 504 to create an arrow representing the individual with MVS scores {WB=30, WR=20, WG=50} and CS scores {CB=50, CR=40, CG=10}. By looking at the arrow graphed onto the SDI® Triangle, it can be easily determined that this particular individual is characterized by a “going well” state within region M3 and a conflict state within region C1. Thus, the arrow represents both states of personality for an assessed individual.

The length of the individual's arrow, which represents the degree of difference between two temporal-affective states (i.e., the well state and the conflict state), can also offer insight into the transition from the “going well” state into the conflict state. Generally, the longer the arrow is, the greater the motivational change the individual, represented by the arrow, experiences as he or she moves from feeling about good himself or herself to feelings of conflict in the first stage. Since behavior arises from motivation, the change in conflict behavior tends to be more noticeable for people represented by long arrows than for people represented by short arrows. Visually speaking, the longer the arrow is, the more likely that the “going well” state, represented by the dot 502, and the conflict state, represented by the arrowhead 504, are positioned within different colors on the SDI® Triangle.

The length of an arrow can be represented using points on the same scale or magnitude as the axis scores. Specifically, the height of the SDI® Triangle is one hundred arbitrary units corresponding to the maximum possible score of one hundred for each of the WB, WR, WG, CB, CR, and CG scores, and the length of an arrow can be calculated using the same arbitrary units as these scores. Generally speaking, an arrow of ten units or less may be considered short, an arrow of ten to twenty-five units may be considered medium, and an arrow of twenty-five unit or more may be considered long.

Notably, multiple individuals may be graphed on the same SDI® Triangle, such that the SDI® Triangle can represent a group or groups of individuals. An example of a SDI® Triangle that represents a group of individuals is illustrated in FIG. 8. As illustrated, the group of individuals may be represented by arrows of varying length, from short, to medium, to long.

Problems with Conventional SDI® Triangles

While the SDI® Triangle has proven to be a useful tool in personality assessment, it has several shortcomings. Firstly, the prior art SDI® Triangle has a circular Hub for the well state, represented by M7 in FIG. 1-8. As a consequence, in close cases, it is difficult to determine and mathematically complex to calculate on which side of the border of Hub M7 a point falls. The prior art SDI® Triangle has a hexagonal Hub inside the circle M7 for the conflict state, represented by C13 in FIG. 1-8. The orientation of this Hub causes difficulty in determining the exact location of a conflict arrowhead, because the ends of areas C3, C10, C6, C11, C9, and C12 alternate between concave V-shape and convex V-shape, as seen in FIG. 2.

Secondly, the conventional SDI® Triangle is a printed diagram with no formal or standard definitions of the various MVS and CS regions. This lack of region definitions also hinders mathematical determinations of the exact MVS or CS region in which a particular point falls. Specifically, in close cases, it can be difficult to determine the side of a border between two MVS or CS regions on which a particular point falls. The lack of region definitions also permits a scenario in which a point may fall exactly on the border between two different MVS or CS regions, leading to ambiguity as to the MVS or CS region in which an individual should be classified.

Accordingly, it is an object of various disclosed embodiments of the present invention to solve one or more of these problems in the utilization of SDI® Triangles.

### SUMMARY

Accordingly, systems, methods, and printed materials are disclosed for a uniquely modified SDI® Triangle that resolves one or more of the problems with conventional SDI® Triangles discussed above.

In an embodiment, a printed material for plotting results of a personality assessment is disclosed. The printed material comprises a triangle that comprises: three sides of equal length; three vertices; three axis lines, wherein each of the three axis lines comprises a first end point at a bisection point of one of the three sides and a second end point at one of the three vertices; seven demarcated motivational-value-system (MVS) regions representing seven well states into which a person is classifiable, wherein the seven MVS regions comprise a hexagon-shaped MVS Hub region in a center of the triangle and six MVS regions surrounding the hexagon-shaped MVS Hub region, and wherein the seven MVS regions cover an entire area of the triangle; and thirteen demarcated conflict-sequence (CS) regions representing thirteen conflict states into which a person is classifiable, wherein the thirteen CS regions comprise a hexagon-shaped CS Hub region in the center of the triangle and twelve CS regions surrounding the hexagon-shaped CS Hub region, and wherein the thirteen CS regions cover the entire area of the triangle so as to overlap the seven MVS regions.

In an additional embodiment, a system for displaying results of a personality assessment is disclosed. The system comprises: at least one hardware processor; and one or more executable software modules that, when executed by the at least one hardware processor, for each of one or more people, receive a plurality of selections from an ipsative assessment completed by the person, calculate a motivational-value-system (MVS) set of scores and a conflict-sequence (CS) set of scores for the person based on the plurality of selections, calculate a first point, corresponding to the MVS set of scores, within a triangle, calculate a second point, corresponding to the CS set of scores, within the triangle, display the triangle with a first indication at the first point and a second indication at the second point, wherein the triangle comprises three sides of equal length, three vertices, seven demarcated MVS regions representing seven well states into which a person is classifiable, wherein the seven MVS regions comprise a hexagon-shaped MVS Hub region in a center of the triangle and six MVS regions surrounding the hexagon-shaped MVS Hub region, and wherein the seven MVS regions cover an entire area of the triangle, thirteen demarcated CS regions representing thirteen conflict states into which a person is classifiable, wherein the thirteen CS regions comprise a hexagon-shaped CS Hub region in the center of the triangle and twelve CS regions surrounding the hexagon-shaped CS Hub region, and wherein the thirteen CS regions cover the entire area of the triangle so as to overlap the seven MVS regions.

In an additional embodiment, a non-transitory computer-readable medium, having one or more sequences of instructions stored therein, is disclosed. The one or more sequences of instructions, when executed by a processor, cause the processor to: receive a plurality of selections from an ipsative assessment completed by the person, calculate a motivational-value-system (MVS) set of scores and a conflict-sequence (CS) set of scores for the person based on the plurality of selections, calculate a first point, corresponding to the MVS set of scores, within a triangle, calculate a second point, corresponding to the CS set of scores, within the triangle, display the triangle with a first indication at the first point and a second indication at the second point, wherein the triangle comprises three sides of equal length, three vertices, seven demarcated MVS regions representing seven well states into which a person is classifiable, wherein the seven MVS regions comprise a hexagon-shaped MVS Hub region in a center of the triangle and six MVS regions surrounding the hexagon-shaped MVS Hub region, and wherein the seven MVS regions cover an entire area of the triangle, thirteen demarcated CS regions representing thirteen conflict states into which a person is classifiable, wherein the thirteen CS regions comprise a hexagon-shaped CS Hub region in the center of the triangle and twelve CS regions surrounding the hexagon-shaped CS Hub region, and wherein the thirteen CS regions cover the entire area of the triangle so as to overlap the seven MVS regions.

In an additional embodiment, a method for displaying results of a personality assessment is disclosed. The method comprises, using at least one hardware processor to: receive a plurality of selections from an ipsative assessment completed by the person, calculate a motivational-value-system (MVS) set of scores and a conflict-sequence (CS) set of scores for the person based on the plurality of selections, calculate a first point, corresponding to the MVS set of scores, within a triangle, calculate a second point, corresponding to the CS set of scores, within the triangle, display the triangle with a first indication at the first point and a second indication at the second point, wherein the triangle comprises three sides of equal length, three vertices, seven demarcated MVS regions representing seven well states into which a person is classifiable, wherein the seven MVS regions comprise a hexagon-shaped MVS Hub region in a center of the triangle and six MVS regions surrounding the hexagon-shaped MVS Hub region, and wherein the seven MVS regions cover an entire area of the triangle, thirteen demarcated CS regions representing thirteen conflict states into which a person is classifiable, wherein the thirteen CS regions comprise a hexagon-shaped CS Hub region in the center of the triangle and twelve CS regions surrounding the hexagon-shaped CS Hub region, and wherein the thirteen CS regions cover the entire area of the triangle so as to overlap the seven MVS regions.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates the MVS regions of a conventional SDI® Triangle;

FIG. 2 illustrates the CS regions of a conventional SDI® Triangle;

FIG. 3-4 illustrate conventional SDI® Triangles;

FIGS. 5-8 illustrate the plotting of representations of personality assessments onto conventional SDI® Triangles;

FIG. 9 illustrates the MVS regions of a modified SDI® Triangle, according to an embodiment;

FIG. 10 illustrates the CS regions of a modified SDI® Triangle, according to an embodiment;

FIG. 11 illustrates a modified SDI® Triangle, according to an embodiment;

FIG. 12 is a flowchart for a process of generating a representation of a personality assessment on a modified SDI® Triangle, according to an embodiment;

FIGS. 13-17 illustrate the plotting of representations of personality assessments onto modified SDI® Triangles, according to an embodiment;

FIG. 18 illustrates a network infrastructure which may be utilized with one or more of the processes described herein, according to an embodiment; and

FIG. 19 illustrates a processing system on which one or more of the processes described herein may be executed, according to an embodiment.

### DETAILED DESCRIPTION

In an embodiment, systems, methods, and printed materials are disclosed for a uniquely modified SDI® Triangle used for personality assessment. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

Improved SDI® Triangle

In an embodiment, a modified SDI® Triangle is provided with improved features over conventional SDI® Triangles. Specifically, these improved features include formal, predetermined definitions for one or more of the MVS and/or CS regions. These definitions may define the boundaries of each represented MVS and/or CS region as a decimal number. Advantageously, in such embodiments, scores in the MVS and CS sets of scores, which are generally always integers or whole numbers (and may be limited to such in certain embodiments), never falls on a boundary between regions. In other words, since the assessment results (i.e., the MVS and CS sets of scores) are limited to whole numbers, and the boundaries between regions are defined as decimal numbers, no test scores fall exactly on a boundary between two regions. Thus, the MVS region and CS region, in which an individual should be classified, can always be precisely determined.

The following table comprises mathematical definitions of the MVS regions or “well types,” according to an embodiment:

TABLE 1
Mathematical Definitions of MVS Well Types

| Ref. | Well Type | Well Blue (WB) | Well Red (WR) | Well Green (WG) |
|---|---|---|---|---|
| M1 | B | WB > 42.3 | WR < 33.3 | WG < 33.3 |
| M2 | R | WB < 33.3 | WR > 42.3 | WG < 33.3 |
| M3 | G | WB < 33.3 | WR < 33.3 | WG > 42.3 |
| M4 | RB | WB > 33.3 | WR > 33.3 | WG < 24.3 |
| M5 | RG | WB < 24.3 | WR > 33.3 | WG > 33.3 |
| M6 | BG | WB > 33.3 | WR < 24.3 | WG > 33.3 |
| M7 | Hub | 24.3 < WB < | 24.3 < WR < | 24.3 < WG < |
| | | 42.3 | 42.3 | 42.3 |

The following table comprises mathematical definitions of the CS regions or “conflict types,” according to an embodiment:

TABLE 2
Mathematical Definitions of CS Conflict Types

| | Con- | Conflict | Conflict | Conflict | |
|---|---|---|---|---|---|
| | flict | Blue | Red | Green | |
| Ref. | Type | (CB) | (CR) | (CG) | Other Test(s) |
| C1 | B-R-G | CB > 39.3 | — | CG < 27.3 | CB-CR > 6.3; |
| | | | | | CR-CG > 6.3 |
| C2 | B-G-R | CB > 39.3 | CR < 27.3 | — | CB-CG > 6.3; |
| | | | | | CG-CR > 6.3 |
| C3 | B-[RG] | CB > 39.3 | — | — | ABS(CR-CG) < |
| | | | | | 6.3 |
| C4 | R-B-G | — | CR > 39.3 | CG < 27.3 | CR-CB > 6.3; |
| | | | | | CB-CG > 6.3 |
| C5 | R-G-B | CB < 27.3 | CR > 39.3 | — | CR-CG > 6.3; |
| | | | | | CG-CB > 6.3 |
| C6 | R-[GB] | — | CR > 39.3 | — | ABS(CB-CG) < |
| | | | | | 6.3 |
| C7 | G-B-R | — | CR < 27.3 | CG > 39.3 | CG-CB > 6.3; |
| | | | | | CB-CR > 6.3 |
| C8 | G-R-B | CB < 27.3 | — | CG > 39.3 | CG-CR > 6.3; |
| | | | | | CR-CB > 6.3 |
| C9 | G-[BR] | — | — | CG > 39.3 | ABS(CB-CR) < |
| | | | | | 6.3 |
| C10 | [BR]-G | — | — | CG < 27.3 | ABS(CB-CR) < |
| | | | | | 6.3 |
| C11 | [RG]-B | CB < 27.3 | — | — | ABS(CR-CG) < |
| | | | | | 6.3 |
| C12 | [BG]-R | — | CR < 27.3 | — | ABS(CB-CG) < |
| | | | | | 6.3 |
| C13 | [BRG] | 27.3 < | 27.3 < | 27.3 < | — |
| | | CB < 39.3 | CR < 39.3 | CG < 39.3 | |

Notably, as discussed above, if the scores of the MVS and CS sets of scores are limited to whole numbers, advantageously, each of the example mathematical definitions in Tables 1 and 2 ensure that none of the well types and conflict types fall on a boundary between two different types, without significantly affecting the classification of individuals using SDI®. The mathematical definitions also facilitate a precise, mathematical computation of MVS and CS types for an individual.

As a result of the mathematical definitions above, which include boundaries lying at decimal numbers (e.g., 24.3, 33.3, and 42.3 for MVS, and 27.3 and 39.3 for CS) as opposed to whole numbers, the border lines between the MVS and CS regions differ from those in a conventional SDI® Triangle. However, for simplicity of understanding, the references used for the regions in the modified SDI® Triangles illustrated herein are the same as those used for the conventional SDI® Triangles. Even though these regions may differ in area and/or shape in the modified SDI® Triangles, they still represent the same well types and conflict types as the analogous regions in conventional SDI® Triangles.

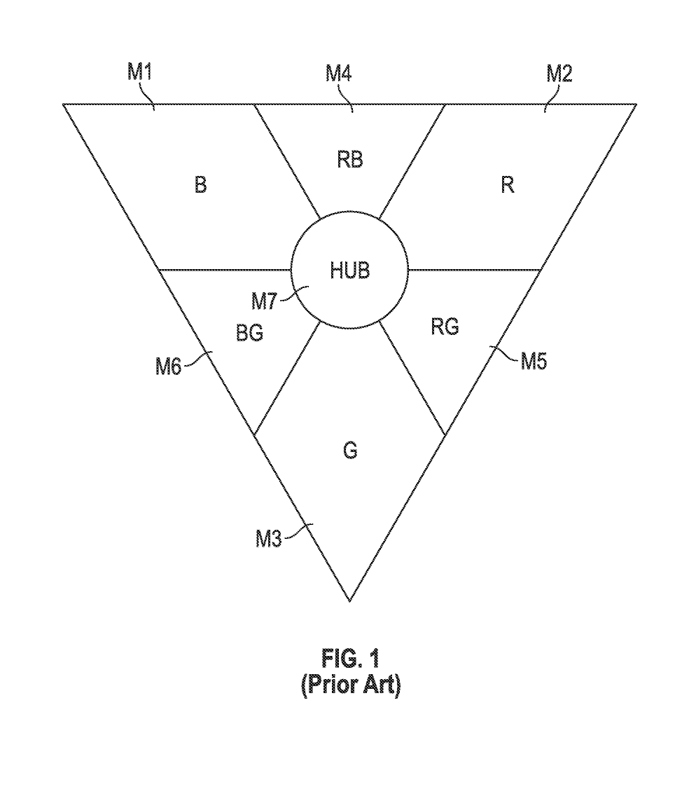

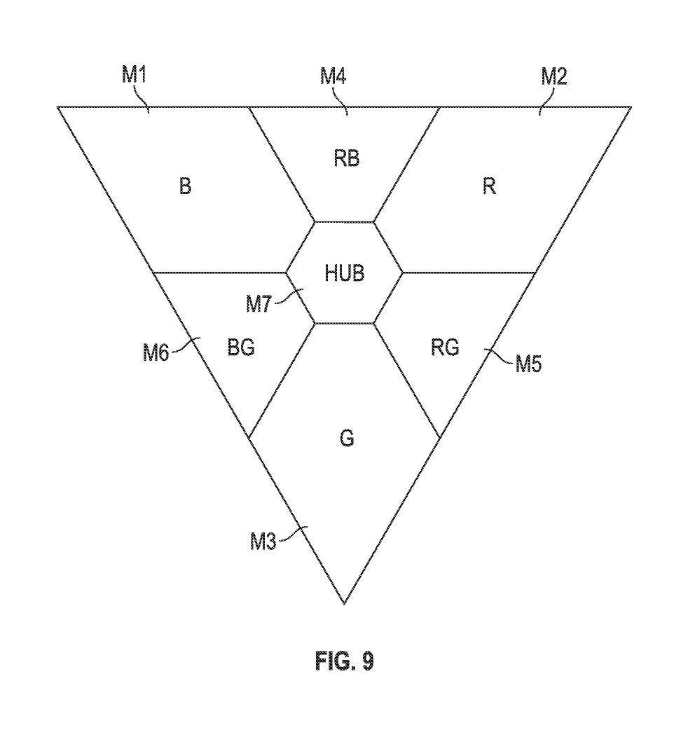

The modified SDI® Triangle for the MVS regions is illustrated in FIG. 9, according to an embodiment utilizing the mathematical definitions in Table 1. As shown, the Hub M7 of the modified SDI® Triangle is a hexagon which is oriented with parallel pairs of sides of the hexagon parallel to respective sides of the SDI® Triangle. In addition, each of the borders between the non-hub MVS regions M1-M6 are also linear, and extend from one of the apices of the hexagon to a side of the triangle along a line that would intersect the middle of the Hub M7. Therefore, all borders between MVS regions M1-M7 are linear, unlike the prior art SDI® triangle, where borders between Hub M7 and regions M1-M6 were arcuate (see FIG. 1). This significantly simplifies calculations. Specifically, since a hexagon comprises no curves, the complicated computations required to determine whether a point falls inside or outside the Hub in a conventional SDI® Triangle are eliminated.

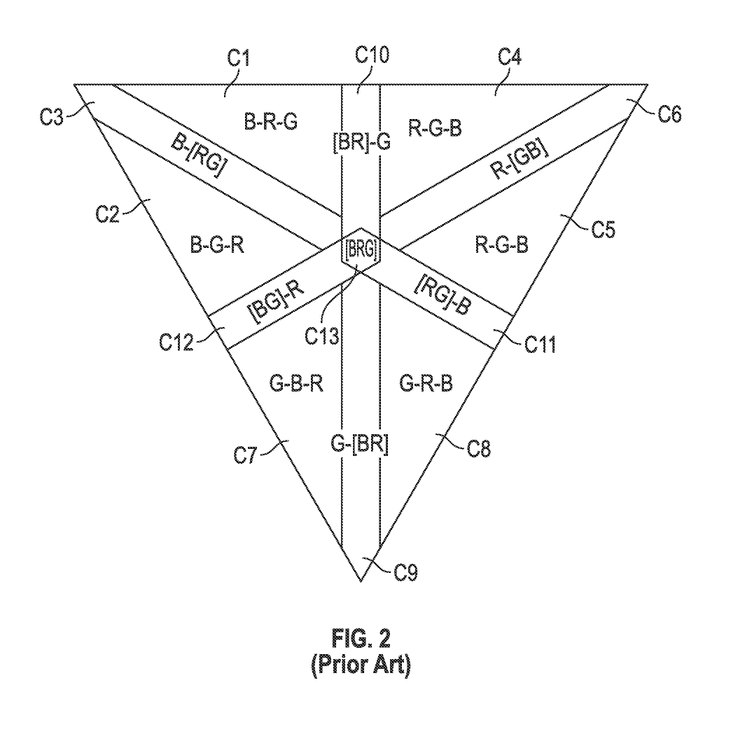

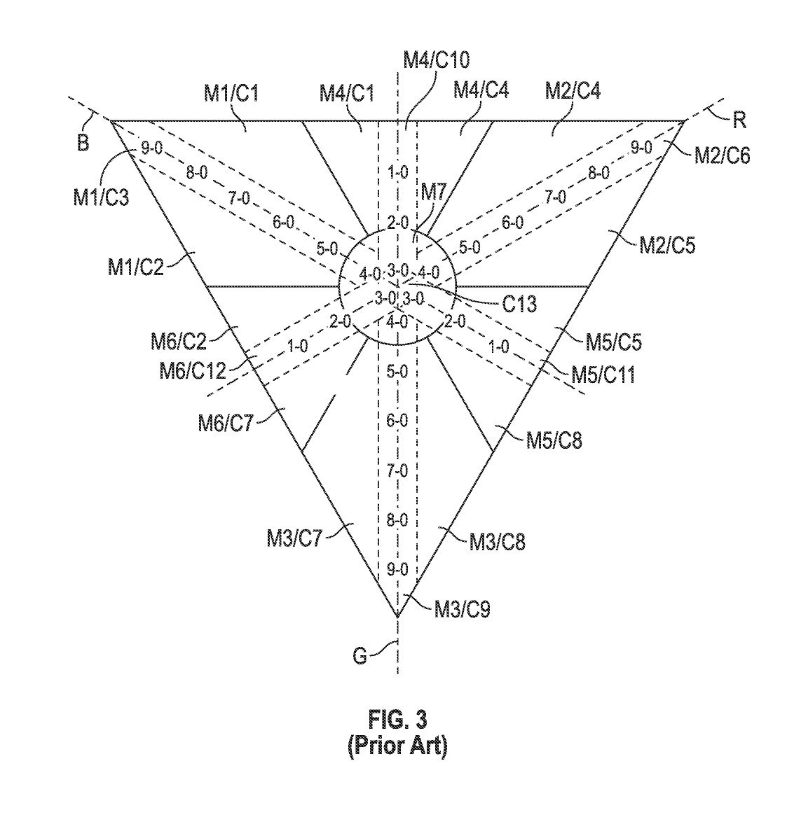

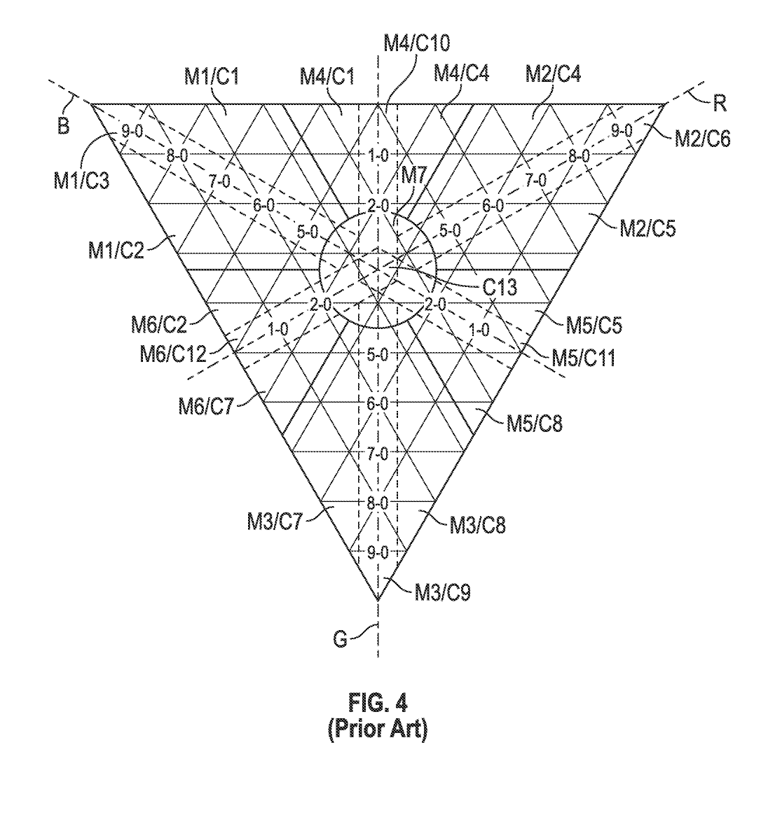

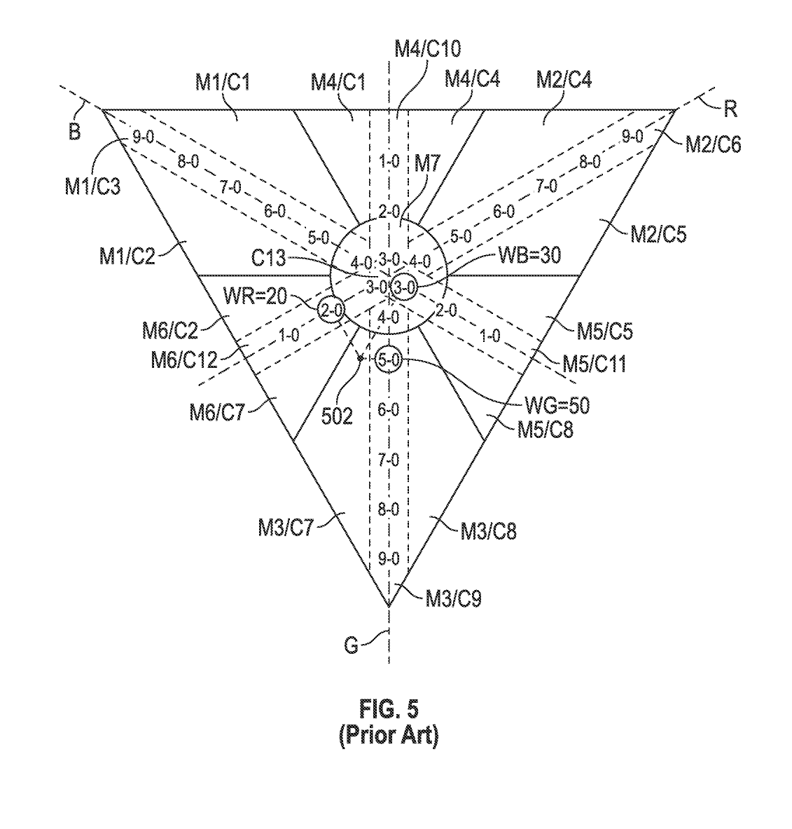

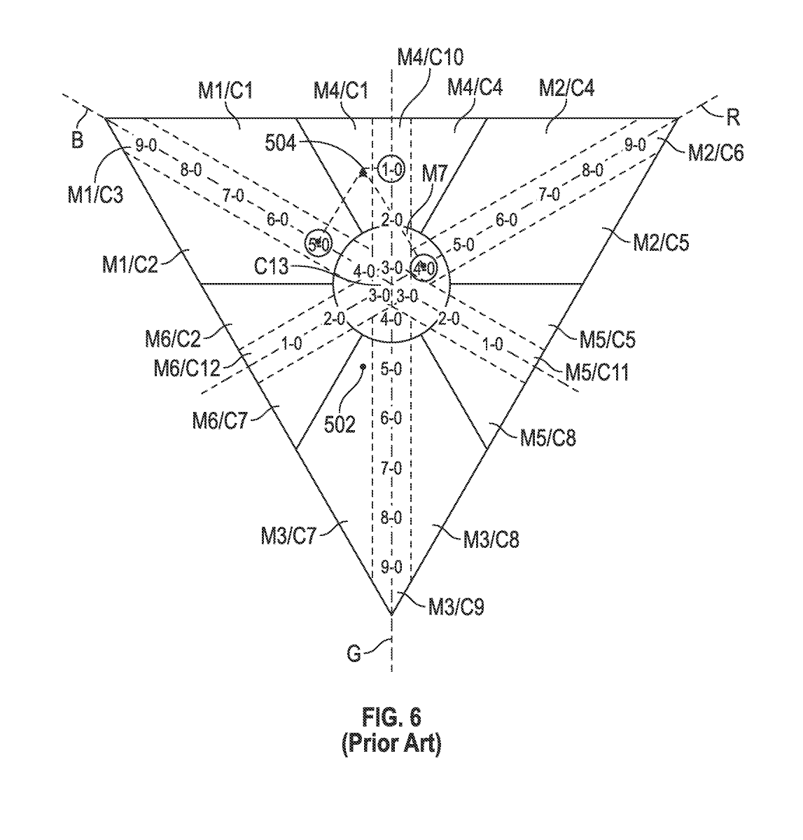

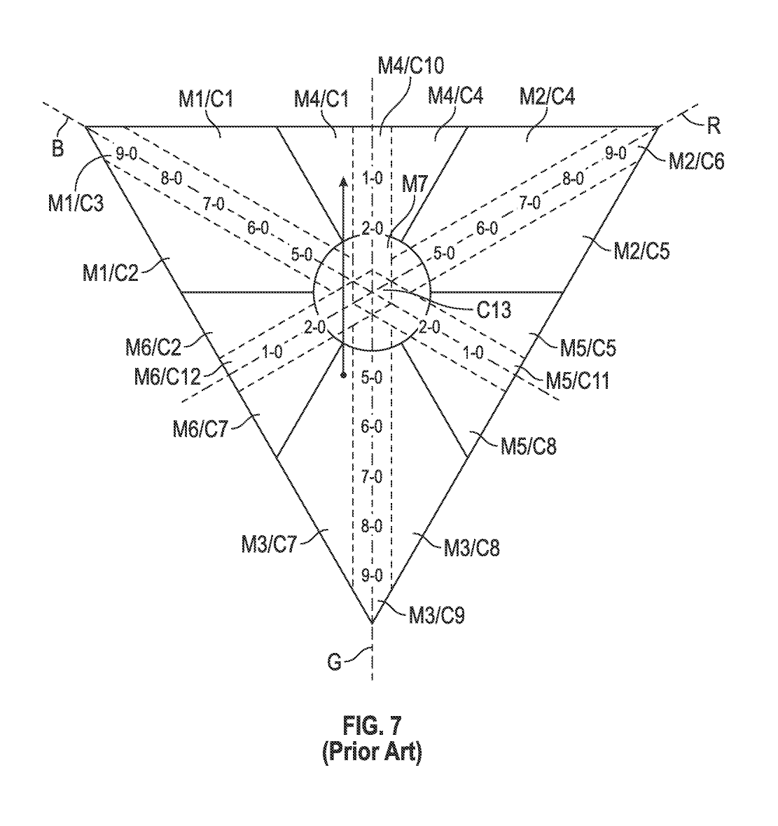

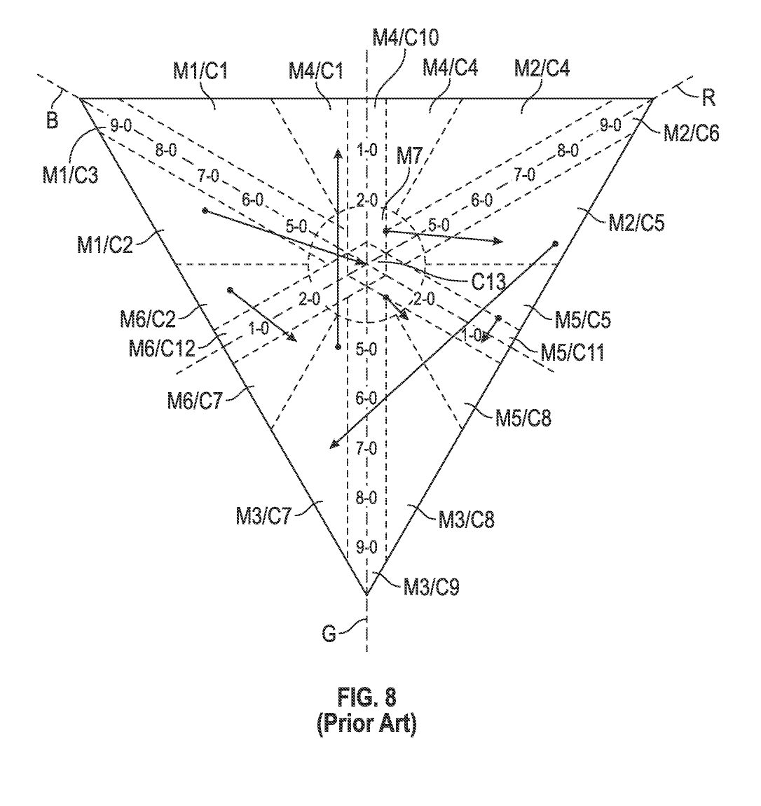

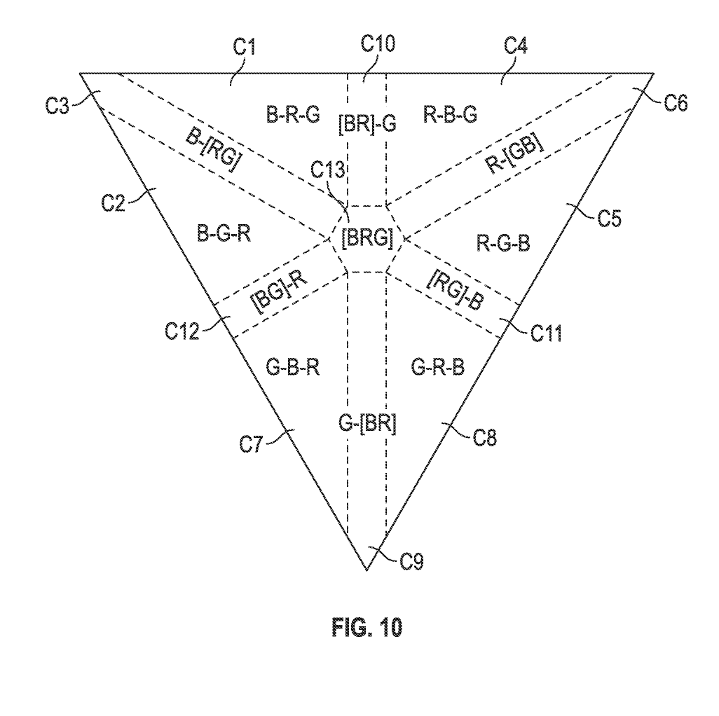

The modified SDI® Triangle for the CS regions is illustrated in FIG. 10, according to an embodiment utilizing the mathematical definitions in Table 2. As shown, the Hub C13 of the modified SDI® Triangle is a hexagon, which is oriented the same way as the hexagon defining Hub M7. Thus, unlike the prior CS Hub C13 of FIG. 2, Hub C13 of FIG. 10 is oriented so that each of the borders between Hub C13 and regions C3, C10, C6, C11, C9 and C12 is a straight line. In addition, each of the borders between the non-hub CS regions C1-C12 are also linear, and extend from one of the apices of the hexagon to a side of the triangle along a line that is perpendicular to a side of the hexagonal Hub C13. Therefore, all borders between CS regions are linear, which significantly simplifies calculations.

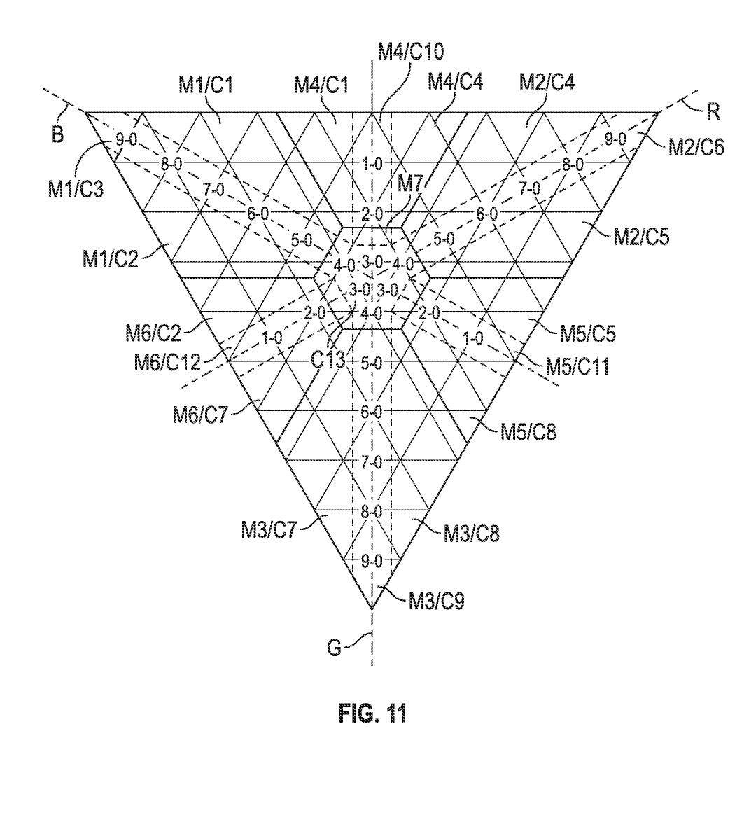

FIG. 11 illustrates the complete modified SDI® Triangle with both the MVS and CS regions, according to an embodiment utilizing the mathematical definitions in Table 1 and Table 2. In the illustrated embodiment, there are markings along each of the B, R, and G axes to aid in the graphing or visualization of points within the SDI® Triangle. Specifically, each axis corresponds to the height the SDI® Triangle and represents a line between a vertex of the SDI® Triangle and a bisection point of a side of the SDI® Triangle at a right angle. Each axis has nine numbered markings, representing ten, twenty, thirty, forty, fifty, sixty, seventy, eighty, and ninety units from the bisection point to the vertex, with the bisection point representing zero units and the vertex representing one hundred units. Nine scale markings (not illustrated) may also be provided between each adjacent pair of numbered markings, dividing the distance between the numbered markings into ten units, so that markings are provided for every unit from one to ninety nine. However, it should be understood that more or fewer markings may be provided (e.g., no markings, markings for every twenty-five units, markings for every five units, etc.).

The embodiment, illustrated in FIG. 11, also depicts the guidelines which may be provided on the modified SDI® Triangle to aid in the graphing or visualization of points within the SDI® Triangle. As shown, for each axis, a guideline that is orthogonal to the axis is provided for every numbered marking on the axis, resulting in twenty-seven total guidelines. However, it should be understood that fewer or more guidelines may be provided (e.g., no guidelines, guidelines for every other marking, guidelines between markings, etc.). For simplicity of illustration, the modified SDI® Triangles used to describe the graphing of individuals' MVS and CS score sets are shown without guidelines.

Graphing on the Improved SDI® Triangle

Graphing on the modified SDI® Triangle may be performed in the same manner as on a conventional SDI® Triangle. Specifically, the MVS set of scores comprises WB, WR, and WG scores, and the CS set of scores comprises CB, CR, and CG scores. Each of these scores is expressed in the same units as each of the B, R, and G axes of the modified SDI® Triangle. Thus, the WB and CB scores can be mapped onto respective points on the B axis, the WR and CR scores can be mapped onto respective points on the R axis, and the WG and CG scores can be mapped onto respective points on the G axis. Each of these points corresponds to a line—which may correspond to a guideline in embodiments which utilize guidelines—that runs orthogonal to its respective axis. The point at which the lines, corresponding to the axis points for the WB, WR, and WG scores, intersect represents an individual's MVS, and may be indicated on the modified SDI® Triangle as a dot. The point at which the lines, corresponding to the axis points for the CB, CR, and CG scores, intersect represents an individual's CS, and may be indicated on the modified SDI® Triangle as an arrowhead. The dot and the arrowhead may then be connected by a line to form an arrow representing an individual. This may be repeated for a plurality of individuals, such that multiple arrows may be depicted on a single modified SDI® Triangle to represent a group or groups of people. While the embodiments illustrated herein utilize an arrow, comprising a dot at one end point and an arrowhead at the other end point, to represent people, it should be understood that other representations may be used (e.g., a line comprising dots at both end points, a line without dots, dots without a line, etc.).

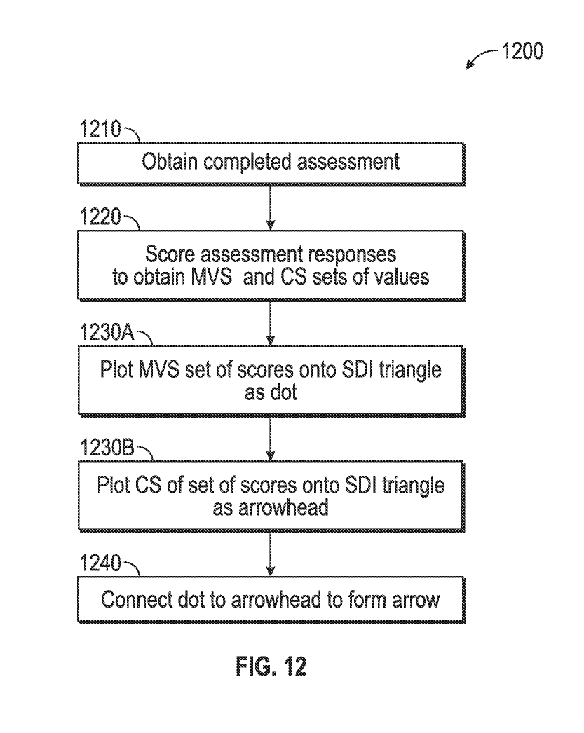

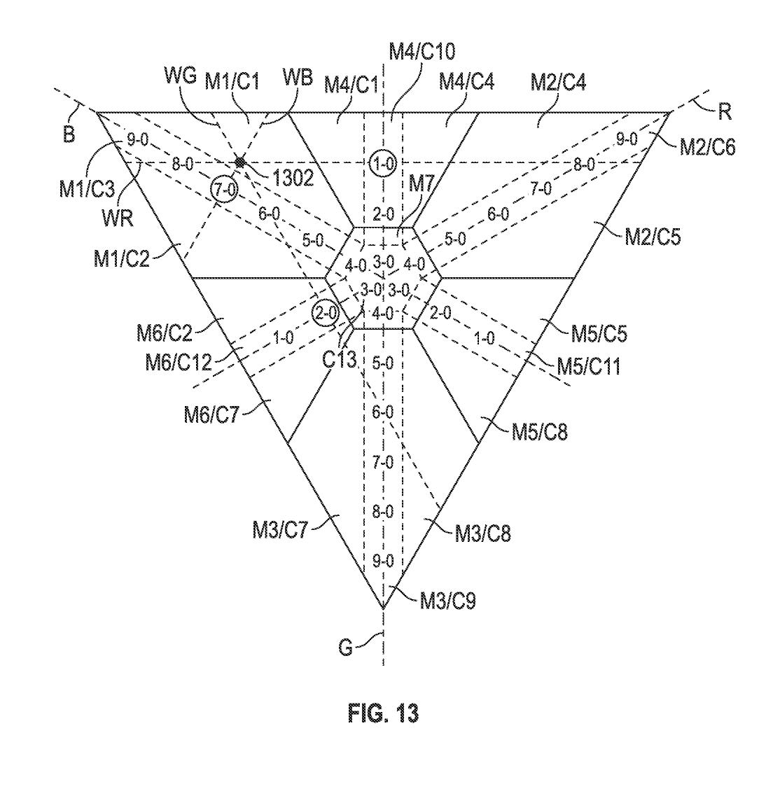

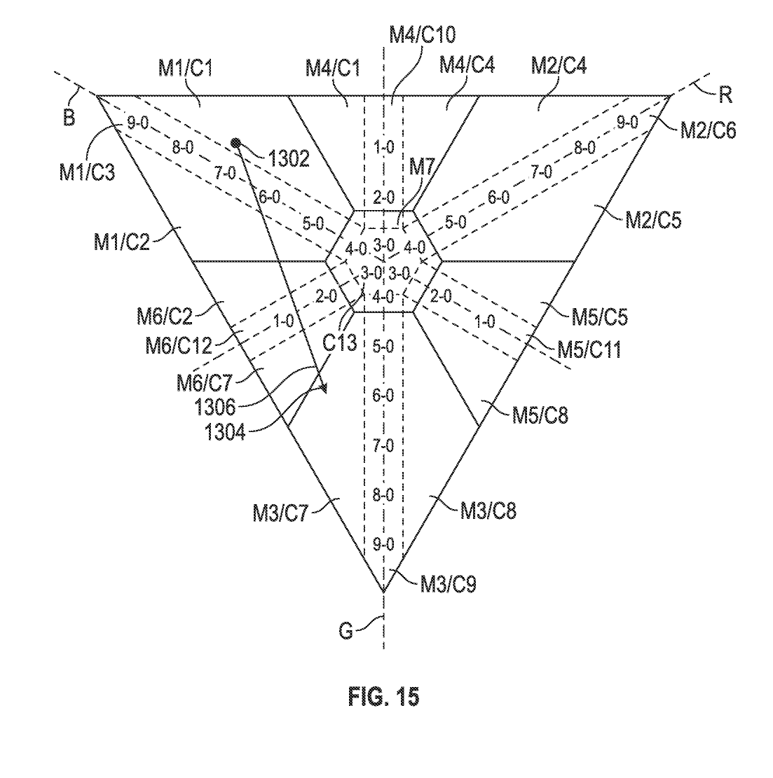

FIGS. 12-16 illustrate a process for mapping a representation of an individual onto a modified SDI® Triangle, according to one example and embodiment. FIG. 12 is a flowchart illustrating a process 1200 for mapping an individual onto a modified SDI® Triangle, according to an embodiment. FIGS. 13-16 illustrate a mapping of an individual onto a modified SDI® Triangle, according to one example and embodiment.

Firstly, a set of MVS and CS scores are obtained for an individual. This may be done using one or more assessments with a series of prompts, for example as described above in connection with the prior art SDI® triangle. A user distributes a total of ten points between each of the three possible responses for each prompt so as to best describe his or her personality, as discussed above and illustrated in step 1210. Each option or response to each prompt may be associated with one of the scores in the set of MVS or CS scores, and all of the options or responses selected by an individual may be scored, in step 1220, to arrive at the set of MVS and CS scores. For instance, if there are ten MVS-related prompts, the user distributes 10 points between each of the three options or responses for each prompt, i.e. each prompt is allocated a number between 0 and 10 such that the total for all three options equals ten. When the totals for each option are summed, the scores for WB, WR and WG add up to 100. For example, an MVS set of scores for an individual might be {WB=30, WR=16, WG=54}. In addition, if there are also ten CS-related prompts, and the individual allocates ten points between the options for each prompt, one example of a CS set of scores for the individual is {CB=25, CR=27, CG=48}. As noted above, the MVS set of scores and CS set of scores sum to one hundred.

It should be understood that the units and number of assessment prompts used are arbitrary. In the illustrated embodiments, the height of the SDI® Triangle is one hundred units and the total number of points allocated for each prompt is ten. However, the height of the SDI® Triangle could be a different number and the number of prompts may be more than ten or less than ten. In fact, any number of assessment prompts can be used, provided that answers to the prompts can be appropriately scored on and/or converted to the same scale as the height of the SDI® Triangle. In other words, the total number of points to be allocated to each prompt is selected so that the total scores add up to the number of units allocated to each axis of the triangle. Furthermore, while, for ease of calculation, the height of the SDI® Triangle is preferably divisible by ten, it should be understood that this is not required.

In step 1230A, the MVS set of scores are plotted onto the modified SDI® Triangle, as a dot or some other indication. FIG. 13 illustrates how one example of an MVS set of scores {WB=70, WR=20, WG=10} may, conceptually, be plotted onto the modified SDI® Triangle to arrive at a single point representing the well state of an individual. In the illustrated embodiment, the point of intersection is indicated as a dot 1302. In FIG. 13, three guidelines are shown to illustrate how the three scores of WB, WR, and WG correspond to three lines which intersect at exactly one point, marked by dot 1302. In an embodiment, there are 5,151 possible three-way intersections for the well state on the SDI® Triangle. However, it should be understood that, in practice, the intersection point, marked by dot 1302, can be found with any two of the lines, as opposed to all three. In other words, the intersection point of any two of the lines is the same as the intersection point of all three of the lines. This is due to the fact that any two of the scores in the MVS set of scores necessarily reveal the third score, since all scores sum to one-hundred units (or whatever other number of units are used as the height of the SDI® Triangle).

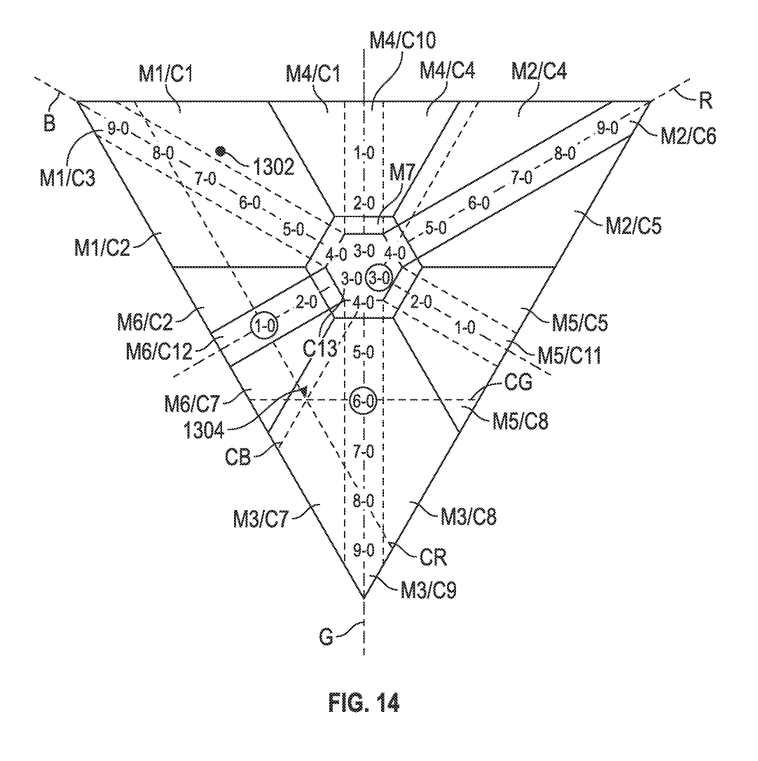

In step 1230B—which may be performed before, after, or in parallel with step 1230A—the CS set of scores are plotted onto the modified SDI® Triangle, as an arrowhead or some other indication. FIG. 14 illustrates how an exemplary CS set of scores {CB=30, CR=10, CG=60} may, conceptually, be plotted onto the modified SDI® Triangle to arrive at a single point representing the conflict sequence of an individual. In the illustrated embodiment, the point of intersection is indicated as an arrowhead 1304. Again, while guidelines are shown for illustration purposes, it should be understood that, in practice, fewer or no guidelines may be used. For example, the intersection points, indicated by 1302 and 1304, may be calculated mathematically (e.g., by a processor), rather than graphically (e.g., by hand). In an embodiment, as with the well state, there are also 5,151 possible three-way intersections for the conflict state on the SDI® Triangle, resulting in 26,532,801 possible permutations of well state and conflict state. Advantageously, this number of permutations permits a high degree of subtlety in the explication of personality test results.

In step 1240, a line 1306 can be displayed or drawn to graphically connect dot 1302 (or other indication) with arrowhead 1304 (or other indication) to form an arrow (or other representation) that represents at least certain aspects of, and may provide insight into, an individual's personality.

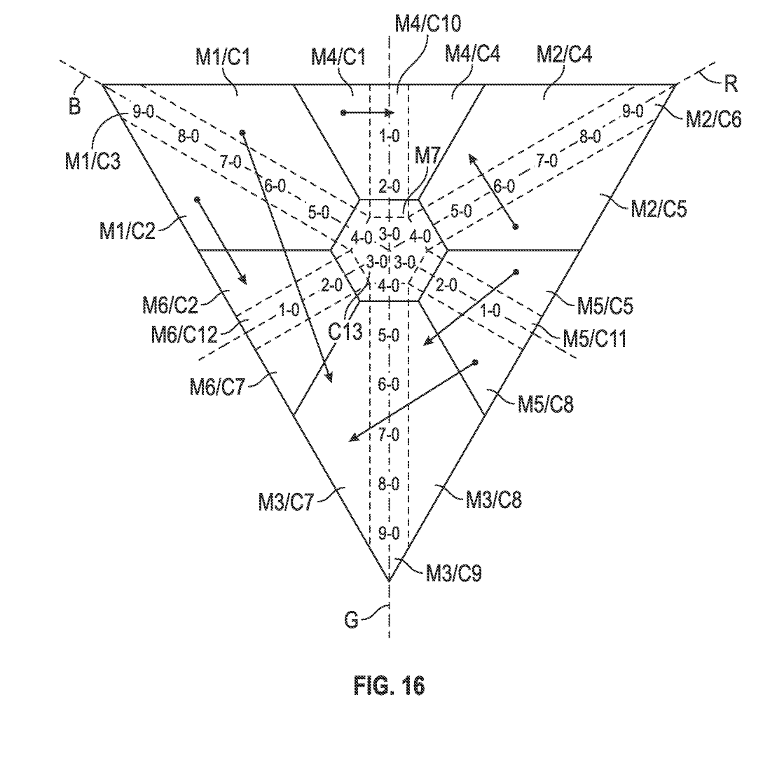

Process 1200 may be repeated for multiple individuals, either on separate modified SDI® Triangles or on the same modified SDI® Triangle. FIG. 16 illustrates representations (arrows, in this example) for multiple people. In this manner, a single, modified SDI® Triangle may be used to represent and provide insights into group(s) of people. For example, a group of related people (e.g., family members, friends, coworkers, colleagues, etc.) may be graphically represented on a single, modified SDI® Triangle.

Printed Material

The modified SDI® Triangle may be provided on printed material as a tool for personality assessment. For example, the modified SDI® Triangle illustrated in FIG. 11 may be printed on a substrate, such as paper. It should be understood that variations to FIG. 11 may be implemented, as needed or desired. For example, fewer or more guidelines may be used, labels may be provided for the various MVS and CS regions, different line weights or formats may be used.

In addition, in a preferred embodiment, colors are used to represent the emphasis of each of the MVS and CS regions. For example, the M1, C1, C2, and C3 regions may each comprise a primarily blue fill, the M2, C4, C5, and C6 regions may comprise a primarily red fill, the M3, C7, C8, and C9 regions may comprise a primarily green fill, and the M7 and C13 regions may comprise a primarily white fill. The blue fill blends towards green and vice versa in the M6, C2, C7, and C12 regions, the blue fill blends towards red and vice versa in the M4, C1, C4, and C10 regions, and the red fill blends towards green and vice versa in the M5, C5, C8, and C11 regions. In addition, all of the fills may blend towards white as they approach hubs M7 and C13.

Furthermore, each axis and, if used, the set of guidelines associated with the axis (i.e., the guidelines orthogonal to the axis) may be represented in their corresponding colors. For example, in an embodiment, the B axis and the guidelines for the B axis are blue, the R axis and guidelines for the R axis are red, and the G axis and the guidelines for the G axis are green.

Test-Retest Reliability

The test-retest reliability of the SDI® measure may be used to determine whether individuals' results are clearly in one of the MVS and/or CS types, or close to the borders of one or more other types. For example, using the MVS={WB=30, WR=20, WG=50} example above, if the numerical results from the assessment(s) resulted in six points more on the WB scale (i.e., WB=36) and three points less on each of the WR and WG scales (i.e., WR=17 and WG=47), the individual would be classified in the M6 (BG) region, rather than the M3 (G) region. Thus, the test-retest reliability gives flexibility in the interpretation of results that are mathematically, and visually, close to boundary-lines.

According to an embodiment, the reliability of the SDI® is plus-or-minus six units. In other words, the variability of the MVS and/or CS between tests taken by the same person can generally vary by up to six units. However, it should be understood that the test-retest reliability can vary for different SDI® tests, and that the test-retest reliability for any particular SDI® test may be determined by experimentation (e.g., using a group of test subjects).

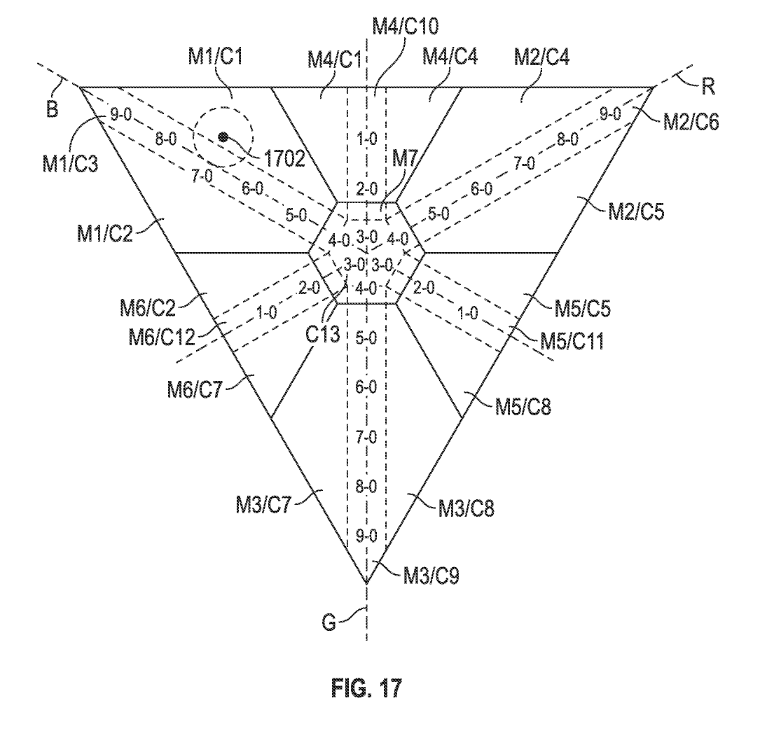

FIG. 17 illustrates a depiction of the test-retest reliability of a point 1702 which, for illustration purposes, can represent either an MVS of {WB=70, WR=20, WG=10} or a CS of {CB=70, CR=20, CG=10}. According to the illustrated embodiment, the reliability, variability, or error of the personality assessment represented by point 1702 is approximately plus-or-minus six. This can be represented by a circle—having a radius equal to the test-retest reliability of the particular SDI® test used (i.e., a radius of six in the illustrated embodiment)—surrounding point 1702, as shown in FIG. 17.

In the depicted example, if point 1702 represents the MVS of an individual, the individual is clearly within MVS region M1 (i.e., Blue). On the other hand, if point 1702 represents the CS of the individual, the individual is in CS region C1 (i.e., B-R-G). However, due to the reliability of plus-or-minus six units, the individual could belong in CS region C3 (i.e., B-[RG]). This is shown by the fact that the circle of radius six surrounding point 1702 overlaps both C1 and C3. In other words, taking the variability of the SDI® test into account, the individual could be classified in either C1 or C3.

System Overview

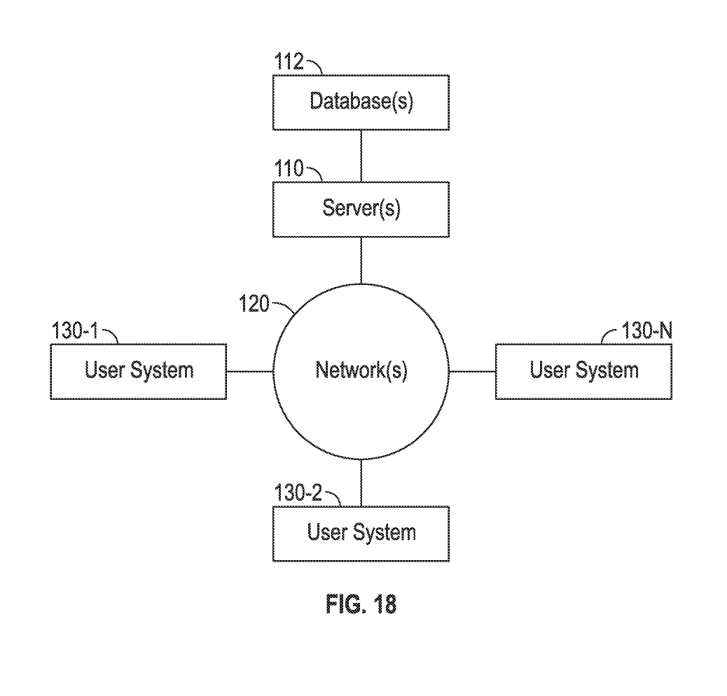

Additionally or as an alternative to the printed materials, the modified SDI® Triangle, disclosed herein, may be rendered by software on an electronic display. FIG. 18 illustrates an example system for generating, displaying, interacting with, and/or otherwise using the modified SDI® Triangle using network-based software, according to an embodiment. However, it should also be understood that the software may be implemented as a stand-alone software package that is capable of running on a user system (e.g., personal computer) with or without network access (e.g., as a downloadable or installable user application or “app”).

All or parts of the process 1200, discussed above with respect to FIG. 12, may be implemented as software modules executed on a personal computing device or using the illustrated system. The illustrated system comprises a set of one or more servers 110 (also referred to herein as a “platform”) which host and/or execute one or more of the various functions, processes, methods, and/or software modules described herein. In addition, server(s) 110 may be communicatively connected to one or more user systems 130 via one or more network(s) 120 and may also be communicatively connected to one or more database(s) 112 (e.g., via one or more network(s), such as network(s) 120) and/or may comprise one or more database(s) 112. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. It should also be understood that server(s) 110 may be, but are not required to be, collocated. Furthermore, while server(s) 110 are illustrated as being connected to various systems through a single set of network(s) 120, it should be understood that server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, and the like. In addition, while only a few user systems 130, one set of server(s) 110, and one set of database(s) 112 are illustrated, it should be understood that the network may comprise any number of user systems, sets of server(s), and database(s).

Platform 110 may comprise web servers which host one or more websites or web services. In embodiments in which a website is provided, the website may comprise one or more user interfaces, including, for example, webpages generated in HyperText Markup Language (HTML) or other language. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to platform 110. Platform 110 may also respond to other requests from user system(s) 130.

Platform 110 may further comprise, be communicatively coupled with, or otherwise have access to one or more database(s) 112. For example, platform 110 may comprise one or more database servers which manage one or more databases 112. A user system 130 or application executing on platform 110 may submit data (e.g., user data, form data, etc.) to be stored in the database(s) 112, and/or request access to data stored in such database(s) 112. Any suitable database may be utilized, including without limitation MySQL™, Oracle™, IBM™, Microsoft SQL™, Sybase™, Access™, and the like, including cloud-based database instances and proprietary databases. Data may be sent to platform 110, for instance, using the well-known POST request supported by HTTP, via FTP, etc. This data, as well as other requests, may be handled, for example, by server-side web technology, such as a servlet or other software module, executed by platform 110.

In embodiments in which a web service is provided, platform 110 may receive requests from user system(s) 130, and provide responses in eXtensible Markup Language (XML) and/or any other suitable or desired format. In such embodiments, platform 110 may provide an application programming interface (API) which defines the manner in which user system(s) 130 may interact with the web service. Thus, user system(s) 130, which may themselves be servers, can define their own user interfaces, and rely on the web service to implement or otherwise provide the backend processes, methods, functionality, storage, etc., described herein. For example, in such an embodiment, a client application executing on one or more user system(s) 130 may interact with a server application executing on platform 110 to execute one or more or a portion of one or more of the various functions, processes, methods, and/or software modules described herein. The client application may be “thin,” in which case processing is primarily carried out server-side by platform 110. A basic example of a thin client application is a browser application, which simply requests, receives, and renders web pages at user system(s) 130, while platform 110 is responsible for generating the web pages and managing database functions. Alternatively, the client application may be “thick,” in which case processing is primarily carried out client-side by user system(s) 130. It should be understood that the client application may perform an amount of processing, relative to platform 110, at any point along this spectrum between “thin” and “thick,” depending on the design goals of the particular implementation. In any case, the application, which may wholly reside on either platform 110 or user system(s) 130 or be distributed between platform 110 and user system(s) 130, can comprise one or more executable software modules that implement one or more of the processes, methods, or functions of the application(s) described herein.

In an embodiment, platform 110 may provide one or more user interfaces for obtaining completed assessment data, as depicted in step 1210 of process 1200. For example, the user interface(s) may comprise inputs for displaying to user(s) assessment(s) comprising a plurality of prompts or questions, each with an associated set of selectable options or answer choices, as discussed above. The user interface(s) may receive selections from the user(s), and optionally store these selections in memory (e.g., database(s) 112). Alternatively or additionally, platform 110 may provide one or more user interfaces for receiving uploads of completed assessments or assessment data, as well as one or more software modules for parsing uploaded assessments or assessment data. In addition, platform 110 may comprise one or more user interfaces for configuring and/or specifying the prompts and options for the assessment(s).

Platform 110 may also comprise one or more software modules that receive the user selections, from the received inputs and/or uploaded assessment data, and score them, as depicted in step 1220, to generate an MVS and CS set of scores based on the user selections of options or answer choices to the prompts or questions of the assessment(s). For example, in an embodiment, the software module(s) may count the number of selected options that correspond to each of the well and conflict types: WB, WR, WG, CB, CR, and CG. These counts can then be used to derive the scores for each of the well and conflict types. In embodiments in which the number of questions is equal to the number of units in the height of the modified SDI® Triangle, the counts themselves may be the scores for the well and conflict types. In other embodiments, the counts may be converted to the scale of the modified SDI® Triangle via a mathematical operation or transformation (e.g., multiplying the counts by ten).

Platform 110 may also comprise one or more software modules that use the mathematical definitions of each of the MVS and CS regions (e.g., the definitions illustrated in Table 1 and Table 2) to determine the MVS region and the CS region in which the individual(s), from whom the assessment answers were received, should be classified. For instance, the software module(s) may test each score in the set of scores against the rules or conditions in Table 1 and Table 2. Using MVS={WB=70, WR=20, WG=10} as an example, the software module(s) would use the conditions in Table 1 to classify the individual into M1 (i.e., well type B), since WB=70>42.3, WR=20<33.3, and WG=10<33.3. In addition, using CS={CB=30, CR=10, CG=60} as an example, the software module(s) would use the conditions in Table 2 to classify the individual into C7 (i.e., conflict sequence G-B-R), since CG=60>39.3, CR=10<27.3, CG-CB=60−30=30>6.3, and CB-CR=30−10=20>6.3.

The determined MVS and CS regions may be displayed in a user interface for an individual or individuals. Alternatively or additionally, the user interface may comprise a rendering (e.g., image) of a modified SDI® Triangle with a representation of the individual(s). For instance, platform 110 may comprise one or more software modules that generate an image of a modified SDI® Triangle with the MVS and CS sets of scores plotted on the SDI® Triangle (e.g., as arrow(s)), as described above.

It should be understood that the user interfaces comprising classifications and/or renderings of modified SDI® Triangles for an individual or group of individuals may be provided to the individual(s) themselves and/or to people other than the individual(s). For example, in an embodiment, platform 110 may collect user-specified options to the prompts of an online assessment from one or more users. Platform 110 may then, for each user, score the options received from that user, and report the results (e.g., classifications and/or SDI® Triangle representation) to the user and/or report the results for each user or for a group of users to someone else (e.g., physician, therapist, employer, supervisor, and/or any other person). In some embodiments, platform 110 may also allow a user to share the results with one or more recipients (e.g., via email, message (e.g., Short Message Service (SMS) text message, Multimedia Messaging Service (MMS), social networking site, fax, etc.).

Example Processing Device

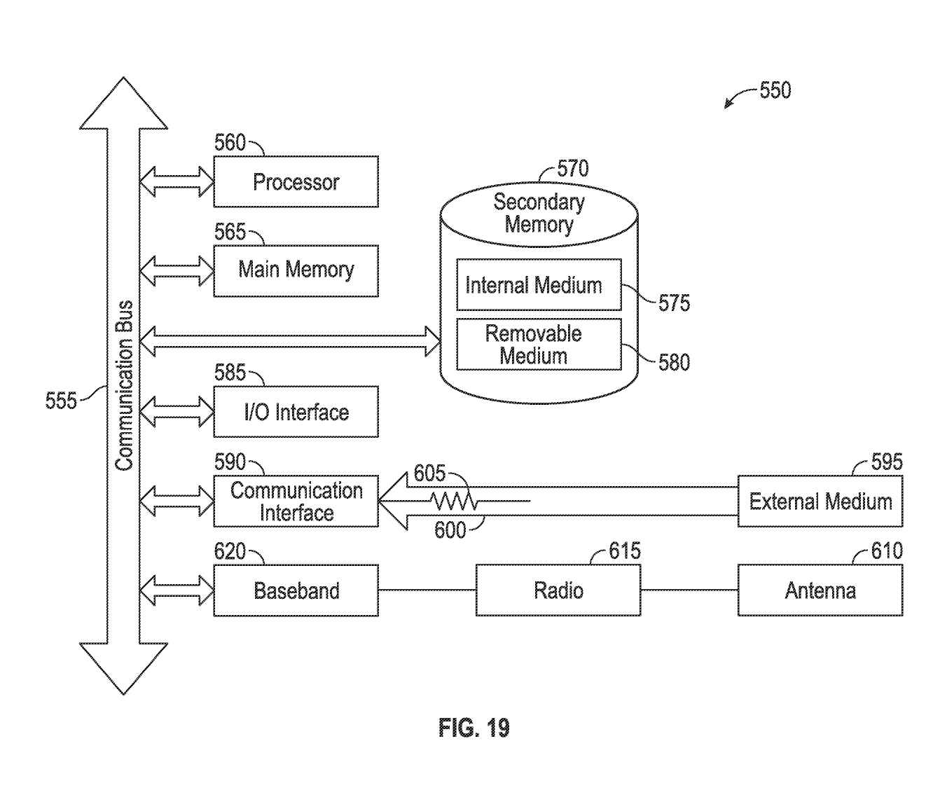

FIG. 19 is a block diagram illustrating an example wired or wireless system 550 that may be used in connection with various embodiments described herein. For example the system 550 may be used as or in conjunction with one or more of the mechanisms, processes, methods, or functions (e.g., to store and/or execute the application or one or more software modules of the application) described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block-oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software, such as the disclosed application) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A material for plotting results of a personality assessment, wherein the material comprises:
a substrate; and
a triangle printed on the substrate, wherein the triangle comprises
three sides of equal length,
three vertices,
three axis lines, wherein each of the three axis lines comprises a first end point at a bisection point of one of the three sides and a second end point at one of the three vertices,
seven demarcated motivational-value-system (MVS) regions representing seven well states into which a person is classifiable,
wherein the seven MVS regions comprise a hexagon-shaped MVS Hub region in a center of the triangle and six MVS regions surrounding the hexagon-shaped MVS Hub region, and
wherein the seven MVS regions cover an entire area of the triangle, and
thirteen demarcated conflict-sequence (CS) regions representing thirteen conflict states into which a person is classifiable,
wherein the thirteen CS regions comprise a hexagon-shaped CS Hub region in the center of the triangle and twelve CS regions surrounding the hexagon-shaped CS Hub region, and
wherein the thirteen CS regions cover the entire area of the triangle so as to overlap the seven MVS regions.

2. The material of claim 1, wherein each of the three axis lines comprise equally-spaced markings demarcating the axis line into a number of equal segments.

3. The material of claim 2, wherein each of the equally-spaced markings comprise a number representing a relative position of the marking along the axis.

4. The material of claim 2, wherein, for each of the three axis lines, the number of equally-spaced markings is nine, such that the number of equal segments is ten.

5. The material of claim 4, wherein, for each of the three axis lines, the nine equally-spaced markings comprise nine different numbers in numerical order from the first end point of the axis to the second end point of the axis.

6. The material of claim 5, wherein, for each of the three axis lines, the nine different numbers comprise ten, twenty, thirty, forty, fifty, sixty, seventy, eighty, and ninety.

7. The material of claim 1, wherein the triangle further comprises three non-white background colors, wherein each of the three non-white background colors is darkest at one of the three vertices and fades into the other two non-white background colors in areas between the vertex at which the non-white background color is darkest and vertices at which the other two non-white background colors are darkest.

8. The material of claim 7, wherein the hexagon-shaped MVS Hub region and the hexagon-shaped CS Hub region have a white background color, and wherein each of the three non-white background colors fades into the white background color as it approaches the hexagon-shaped MVS Hub region and the hexagon-shaped CS Hub region.

9. The material of claim 7, wherein each of the three axis lines is the same color as the non-white background color that is darkest at the vertex at which the second end point of the axis line is located.

10. The material of claim 9, wherein the triangle further comprises, for each of the three axis lines, a plurality of guidelines that are orthogonal to the axis line and are the same color as the axis line.

11. The material of claim 9, wherein the three non-white background colors comprise blue, red, and green.

12. The material of claim 1, further comprising one or more arrows within the triangle, wherein, for each of the one or more arrows, an arrowhead of the arrow is located within one of the thirteen CS regions and an end point of the arrow that is opposite the arrowhead is located within one of the seven MVS regions.

13. The material of claim 11, wherein the one or more arrows comprise a plurality of arrows.

14. The material of claim 1, wherein each of the six MVS regions surrounding the hexagon-shaped MVS Hub region are defined by a portion of one or more sides of the triangle, a line of the hexagon-shaped MVS Hub region, and two lines adjoining adjacent vertices of the hexagon-shaped MVS Hub region at 120° angles with respect to the line of the hexagon-shaped MVS Hub region.

15. The material of claim 14, wherein the hexagon-shaped MVS Hub region is defined by, along each of the three axes, a first orthogonal line at 24.3% of a length of the axis from its first end point to its second end point and a second orthogonal line at 42.3% of the length of the axis from its first end point to its second end point.

16. The material of claim 14, wherein the twelve CS regions surrounding the hexagon-shaped CS Hub region comprise:
a first set of six CS regions defined by a portion of one or more sides of the triangle, a line of the hexagon-shaped CS Hub region, and two lines adjoining adjacent vertices of the hexagon-shaped CS Hub region at 90° angles with respect to the line of the hexagon-shaped CS Hub region; and
a second set of six CS regions comprising triangles defined by a portion of one side of the triangle, and lines of two CS regions in the first set of six CS regions.

17. The material of claim 16, wherein the hexagon-shaped CS Hub region is defined by, along each of the three axes, a first orthogonal line at 27.3% of the length of the axis from its first end point to its second end point and a second orthogonal line at 39.3% of the length of the axis from its first end point to its second end point.

18. The material of claim 16, wherein each MVS region is at least partially defined by MVS border lines within the triangle which form boundaries between different MVS types, each CS region is at least partially defined by CS border lines within the triangle which form boundaries between different CS types, and each MVS and CS boundary is oriented transverse to a respective axis at a distance along the respective axis which corresponds to a decimal number percentage of the length of the respective axis.

19. A system for displaying results of a personality assessment, the system comprising:
at least one hardware processor; and
one or more executable software modules that, when executed by the at least one hardware processor, for each of one or more people,
receive a plurality of selections from an ipsative assessment completed by the person,
calculate a motivational-value-system (MVS) set of scores and a conflict-sequence (CS) set of scores for the person based on the plurality of selections,
calculate a first point, corresponding to the MVS set of scores, within a triangle,
calculate a second point, corresponding to the CS set of scores, within the triangle,
display the triangle with a first indication at the first point and a second indication at the second point, wherein the triangle comprises
three sides of equal length,
three vertices,
seven demarcated MVS regions representing seven well states into which a person is classifiable, wherein the seven MVS regions comprise a hexagon-shaped MVS Hub region in a center of the triangle and six MVS regions surrounding the hexagon-shaped MVS Hub region, and wherein the seven MVS regions cover the entire area of the triangle,
thirteen demarcated CS regions representing thirteen conflict states into which a person is classifiable, wherein the thirteen CS regions comprise a hexagon-shaped CS Hub region in the center of the triangle and twelve CS regions surrounding the hexagon-shaped CS Hub region, and wherein the thirteen CS regions cover the entire area of the triangle so as to overlap the seven MVS regions.

20. The system of claim 19, wherein the triangle further comprises three non-white background colors, wherein each of the three non-white background colors is darkest at one of the three vertices and fades into the other two non-white background colors in areas between the vertex at which the non-white background color is darkest and vertices at which the other two non-white background colors are darkest.

21. The system of claim 20, wherein the hexagon-shaped MVS Hub region and the hexagon-shaped CS Hub region have a white background color, and wherein each of the three non-white background colors fades into the white background color as it approaches the hexagon-shaped MVS Hub region and the hexagon-shaped CS Hub region.

22. The system of claim 20, wherein the three non-white background colors comprise blue, red, and green.

23. The system of claim 19, wherein the first indication is a dot and the second indication is an arrowhead, and wherein displaying the triangle with a first indication at the first point and a second indication at the second point comprises displaying an arrow comprising the dot, the arrowhead, and a line connecting the dot to the arrowhead.

24. The system of claim 19, wherein the hexagon-shaped MVS Hub region is defined by, along each of three axes of the triangle bisecting one of the three sides and one of the three vertices, a first orthogonal line at 24.3% of a length of the axis from the side to the vertex and a second orthogonal line at 42.3% of the length of the axis from the side to the vertex, and wherein each of the six MVS regions surrounding the hexagon-shaped MVS Hub region are defined by a portion of one or more sides of the triangle, a line of the hexagon-shaped MVS Hub region, and two lines adjoining adjacent vertices of the hexagon-shaped MVS Hub region at 120° angles with respect to the line of the hexagon-shaped MVS Hub region.

25. The system of claim 24, wherein the hexagon-shaped CS Hub region is defined by, along each of the three axes, a first orthogonal line at 27.3% of the length of the axis from the side to the vertex and a second orthogonal line at 39.3% of the length of the axis from the side to the vertex, and wherein the twelve CS regions surrounding the hexagon-shaped CS Hub region comprise:
a first set of six CS regions defined by a portion of one or more sides of the triangle, a line of the hexagon-shaped CS Hub region, and two lines adjoining adjacent vertices of the hexagon-shaped CS Hub region at 90° angles with respect to the line of the hexagon-shaped CS Hub region; and
a second set of six CS regions comprising triangles defined by a portion of one side of the triangle, and lines of two CS regions in the first set of six CS regions.

26. The system of claim 25, wherein each score in the MVS set of scores and each score in the CS set of scores is an integer.

27. The system of claim 19, wherein each score in the MVS set of scores and each score in the CS set of scores is an integer, each MVS region is at least partially defined by MVS border lines within the triangle which form boundaries between different MVS types, each CS region is at least partially defined by CS border lines within the triangle which form boundaries between different CS types, and each MVS and CS boundary is oriented transverse to a respective axis at a distance along the respective axis which corresponds to a decimal number percentage of the length of the respective axis, whereby no displayed indication at a calculated point on the triangle lies on a boundary between two regions.

28. The system of claim 19, wherein one or both of the first indication and the second indication comprises a dot representing the respective point and a circle with the dot as its center, wherein the circle has a radius equal to a test-retest reliability of the ipsative assessment.

29. A non-transitory computer-readable medium having one or more sequences of instructions stored therein, wherein the one or more sequences of instructions, when executed by a processor, cause the processor to:
receive a plurality of selections from an ipsative assessment completed by the person,
calculate a motivational-value-system (MVS) set of scores and a conflict-sequence (CS) set of scores for the person based on the plurality of selections,
calculate a first point, corresponding to the MVS set of scores, within a triangle,
calculate a second point, corresponding to the CS set of scores, within the triangle,
display the triangle with a first indication at the first point and a second indication at the second point, wherein the triangle comprises
three sides of equal length,
three vertices,
seven demarcated MVS regions representing seven well states into which a person is classifiable, wherein the seven MVS regions comprise a hexagon-shaped MVS Hub region in a center of the triangle and six MVS regions surrounding the hexagon-shaped MVS Hub region, and wherein the seven MVS regions cover an entire area of the triangle,
thirteen demarcated CS regions representing thirteen conflict states into which a person is classifiable, wherein the thirteen CS regions comprise a hexagon-shaped CS Hub region in the center of the triangle and twelve CS regions surrounding the hexagon-shaped CS Hub region, and wherein the thirteen CS regions cover the entire area of the triangle so as to overlap the seven MVS regions.

30. The non-transitory computer-readable medium of claim 29, wherein the triangle further comprises three non-white background colors, wherein each of the three non-white background colors is darkest at one of the three vertices and fades into the other two non-white background colors in areas between the vertex at which the non-white background color is darkest and vertices at which the other two non-white background colors are darkest.

31. The non-transitory computer-readable medium of claim 30, wherein the hexagon-shaped MVS Hub region and the hexagon-shaped CS Hub region have a white background color, and wherein each of the three non-white background colors fades into the white background color as it approaches the hexagon-shaped MVS Hub region and the hexagon-shaped CS Hub region.

32. The non-transitory computer-readable medium of claim 29, wherein the three non-white background colors comprise blue, red, and green.

33. The non-transitory computer-readable medium of claim 29, wherein the first indication is a dot and the second indication is an arrowhead, and wherein displaying the triangle with a first indication at the first point and a second indication at the second point comprises displaying an arrow comprising the dot, the arrowhead, and a line connecting the dot to the arrowhead.

34. The non-transitory computer-readable medium of claim 29, wherein the hexagon-shaped MVS Hub region is defined by, along each of three axes of the triangle bisecting one of the three sides and one of the three vertices, a first orthogonal line at 24.3% of a length of the axis from the side to the vertex and a second orthogonal line at 42.3% of the length of the axis from the side to the vertex, and wherein each of the six MVS regions surrounding the hexagon-shaped MVS Hub region are defined by a portion of one or more sides of the triangle, a line of the hexagon-shaped MVS Hub region, and two lines adjoining adjacent vertices of the hexagon-shaped MVS Hub region at 120° angles with respect to the line of the hexagon-shaped MVS Hub region.

35. The non-transitory computer-readable medium of claim 34, wherein the hexagon-shaped CS Hub region is defined by, along each of the three axes, a first orthogonal line at 27.3% of the length of the axis from the side to the vertex and a second orthogonal line at 39.3% of the length of the axis from the side to the vertex, and wherein the twelve CS regions surrounding the hexagon-shaped CS Hub region comprise:
a first set of six CS regions defined by a portion of one or more sides of the triangle, a line of the hexagon-shaped CS Hub region, and two lines adjoining adjacent vertices of the hexagon-shaped CS Hub region at 90° angles with respect to the line of the hexagon-shaped CS Hub region; and
a second set of six CS regions comprising triangles defined by a portion of one side of the triangle, and lines of two CS regions in the first set of six CS regions.

36. The non-transitory computer-readable medium of claim 35, wherein each score in the MVS set of scores and each score in the CS set of scores is an integer.

37. The non-transitory computer-readable medium of claim 29, wherein each score in the MVS set of scores and each score in the CS set of scores is an integer, each MVS region is at least partially defined by MVS border lines within the triangle which form boundaries between different MVS types, each CS region is at least partially defined by CS border lines within the triangle which form boundaries between different CS types, and each MVS and CS boundary is oriented transverse to a respective axis at a distance along the respective axis which corresponds to a decimal number percentage of the length of the respective axis, whereby no displayed indication at a calculated point on the triangle lies on a boundary between two regions.

38. The non-transitory computer-readable medium of claim 29, wherein one or both of the first indication and the second indication comprises a dot representing the respective point and a circle with the dot as its center, wherein the circle has a radius equal to a test-retest reliability of the ipsative assessment.
